(19) United States
(12) Patent Application Publication
(10) Pub. No.: US 2019/0344537 A1
(43) Pub. Date: Nov. 14, 2019

(54) UNCURED INSULATION ARTICLES COMPRISING CORROSION INHIBITORS AND METHODS OF PRODUCING THE SAME

(71) Applicant: KNAUF INSULATION, INC., Shelbyville, IN (US)

(72) Inventors: Christopher George Hardy, Franklin, IN (US); John P. Wade, Shelbyville, IN (US); Michael Dean Hoops, Brownsburg, IN (US); Charles Fitch Appley, Cumberland, IN (US); Robert W. Zembrodt, Indianapolis, IN (US)

(73) Assignee: Knauf Insulation, Inc.

(21) Appl. No.: 16/404,274

(22) Filed: May 6, 2019

Related U.S. Application Data
(60) Provisional application No. 62/669,936, filed on May 10, 2018.

(51) Int. Cl. B32B 7/12; C09D 5/08; F24F 13/02; F16L 59/02; B32B 15/098; B32B 15/082; B32B 15/09; B32B 15/18; B32B 27/18; B32B 27/30; B32B 27/36; B32B 27/42; B32B 37/02; B32B 37/12; B32B 37/18

(52) U.S. Cl. CPC B32B 7/12; B32B 2361/00; C09D 5/086; F24F 13/0263; F24F 13/0245; F16L 59/028; F16L 59/029; B32B 15/098; B32B 15/082; B32B 15/09; B32B 15/18; B32B 27/18; B32B 27/308; B32B 27/36; B32B 27/42; B32B 37/02; B32B 37/12; B32B 37/182; B32B 2037/1276; B32B 2255/06; B32B 2255/10; B32B 2255/20; B32B 2255/24; B32B 2307/304; B32B 2307/752; B32B 2305/22; B32B 2305/72; B32B 2305/77; B32B 2311/30; B32B 2262/101; B32B 2262/108; B32B 2333/08; B32B 2367/00; C09D 5/084

(57) ABSTRACT

The present disclosure generally relates to insulation articles including corrosion inhibitors and methods of producing the same are disclosed. In some embodiments, an article of manufacture comprising an insulation mat comprising an uncured combination of a plurality of randomly oriented fibers and a binder is provided. In further embodiments, the insulation mat extends between a first surface and a second surface, and a veil attached to the first surface and structured to inhibit physical movement of the cured combination through the veil is provided, as well as a metal sheet attached to the second surface by a water-containing adhesive contacting the metal sheet and the second surface, and a corrosion inhibitor composition deposited on the cured combination of the insulation mat, wherein the corrosion inhibitor composition is capable of modifying toward neutral a pH of the cured combination in contact with water from the water-containing adhesive.

### CROSS-REFERENCE TO RELATED APPLICATIONS

This application claims priority to U.S. Application Ser. No. 62/669,936, filed May 10, 2018, the entire disclosure of which is expressly incorporated by reference herein.

### BACKGROUND OF THE INVENTION

The present application relates generally to insulation materials or articles of manufacture including corrosion inhibitors and methods of producing the same. To form mineral wool insulation materials and articles, such as those comprising fiberglass and/or rock wool, one or more binder compositions may be combined with mineral wool fibers and the binder/fiber combination may be uncured to provide an insulation mat, which may alternatively be referred to as an insulation blanket or simply a blanket. The inventors have discovered that the characteristics of various uncured binder/fiber compositions may contribute to undesired consequences in certain applications, including those where the uncured binder/fiber compositions is ultimately cured for commercial applications. For example, the pH characteristics of uncured binder/fiber compositions may accelerate or contribute to corrosion or hazing of metal material which come into contact with or proximity with either cured or additional, uncured binder/fiber compositions. As one non-limiting example, duct liner articles may be constructed by affixing one side of an insulation mat comprising an uncured binder/fiber combination to a metal sheet and affixing a veil to an opposite side of the mat. During production the “show side” (the side that would be visible in the commercial product) of the metal sheet for one duct liner article may come into contact or proximity with the veil of another duct liner article resulting in corrosion or hazing of the show side that may diminish the commercial value of the affected product. This effect may occur even when sheet metal with a galvanized show side is utilized. A significant need therefore remains for unique insulation materials or articles of manufacture comprising corrosion inhibitors and methods of producing the same.

### SUMMARY OF THE INVENTION

The present disclosure generally relates to insulation articles comprising corrosion inhibitors and methods of producing the same. In some embodiments, the disclosure relates to an article of manufacture comprising a) an insulation mat comprising an uncured combination of a plurality of randomly oriented fibers comprising fiberglass fibers or rock wool fibers and a non-phenol formaldehyde (non-PF) composition binder, wherein the insulation mat extends between a first surface and a second surface; b) a veil attached to the first surface, wherein the veil is structured to inhibit physical movement of the cured combination through the veil; c) a metal sheet attached to the second surface by a water-containing adhesive contacting the metal sheet and the second surface; and d) a corrosion inhibitor composition deposited on the uncured combination of the insulation mat, wherein the corrosion inhibitor composition modifies toward neutral a pH of the uncured combination in contact with water from the water-containing adhesive.

In some embodiments, the uncured combination has an acidic pH and the corrosion inhibitor composition has an alkaline pH. In further embodiments, the corrosion inhibitor composition comprises a water soluble compound selected from the group consisting of sodium hydroxide, sodium carbonate, sodium bicarbonate, potassium hydroxide, potassium carbonate, potassium bicarbonate, ammonium carbonate, ammonium bicarbonate, monoethanolamine, diethanolamine, triethanolamine and combinations thereof. In still further embodiments, the corrosion inhibitor composition comprises a water insoluble compound selected from the group consisting of zinc phosphate, calcium phosphate, a long chain alkyl imidazoline and combinations thereof. In additional embodiments, the corrosion inhibitor composition is deposited on the first surface of the insulation mat. In certain embodiments, the binder is selected from an acrylic binder, a polyester-type binder, a binder comprising at least one reaction product from a Maillard reaction, and combinations thereof.

In some embodiments, the binder comprises a polyester-type binder selected from the group consisting of 1) a monomeric polycarboxylic acid and a monomeric polyol; 2) a polymeric polycarboxylic acid and a monomeric polyol; 3) a monomeric polycarboxylic acid and a polymeric polyol; and 4) a polymeric polycarboxylic acid and a polymeric polyol. In further embodiments, the binder comprises at least one or more of a) at least one reaction product from a Maillard reaction; b) at least one product of a carbohydrate and an amine reactant; and c) at least one product of a reducing sugar reactant and a polycarboxylic acid ammonium salt reactant. In still further embodiments, the metal sheet is galvanized.

In some embodiments, the present disclosure relates to a curable article of manufacture comprising a) an insulation mat comprising an uncured combination of a plurality of randomly oriented fibers and a binder, the insulation mat comprising a corrosion inhibitor composition and extending between a first surface and a second surface, wherein the corrosion inhibitor comprises the opposite of one of the acidic pH and the alkaline pH of the uncured composition when immersed in deionized water; and b) a veil attached to the first surface, the veil structured to inhibit physical movement of the cured combination through the veil. In further embodiments, the curable article comprises a metal sheet attached to the second surface by a water-comprising adhesive contacting the metal sheet and the second surface. In still further embodiments, the corrosion inhibitor composition is effective to modify toward neutral a pH of the uncured combination in contact with water from the water-containing adhesive. In additional embodiments, the veil is positioned in contact with a surface of a second, galvanized metal sheet. In certain embodiments, the corrosion inhibitor composition provides passivation of the surface of the second metal sheet. In additional embodiments, the binder comprises at least one reaction product from a Maillard reaction, the uncured composition has an acidic pH, and the corrosion inhibitor composition has an alkaline pH.

In some embodiments, the disclosure relates to a method comprising a) providing an insulation mat comprising an uncured combination of a plurality of randomly oriented fibers and a binder and a veil attached to a first surface of the cured combination and effective to inhibit physical movement of the cured combination through the veil; b) applying a corrosion inhibitor composition to the uncured combination of the insulation mat; c) curing the uncured combination of a plurality of randomly oriented fibers, a binder, a veil and a corrosion inhibitor; d) attaching a metal sheet to a second surface of the cured combination with a water-containing adhesive contacting the metal sheet and the second surface; and e) contacting the veil with a second metal sheet; wherein the corrosion inhibitor composition is effective to inhibit a reaction of water from the water-containing adhesive, the uncured combination and the second metal sheet.

In further embodiments, the corrosion inhibitor composition is effective to modify toward neutral a pH of the uncured combination in contact with water from the water-containing adhesive. In still further embodiments, the corrosion inhibitor composition is effective to passivate a surface of the second metal sheet. In additional embodiments, the act of applying comprises applying the corrosion inhibitor composition to a second surface of the uncured combination of the insulation mat, the second surface being opposite from the first surface. In certain embodiments, the corrosion inhibitor composition is applied to the second surface by spraying an aqueous solution comprising the corrosion inhibitor composition and an aqueous slurry including the corrosion inhibitor composition. As would be appreciated by those of skill in the relevant art, further embodiments, forms, objects, features, advantages, aspects, and benefits may become apparent from the following description and drawings.

### BRIEF DESCRIPTION OF THE DRAWINGS

FIG. 1 is a partial side sectional view of a plurality of duct liner insulation articles according to certain embodiments of the disclosed technology.

FIG. 2 is a partial side sectional view of a plurality of duct liner insulation articles in accordance with some embodiments of the disclosure.

FIG. 3 is a partial side sectional view of a plurality of duct liner insulation articles according to certain embodiments of the disclosed technology.

FIG. 4 is a partial side sectional view of a plurality of duct liner insulation articles in accordance with some embodiments of the disclosure.

### DETAILED DESCRIPTION OF THE INVENTION

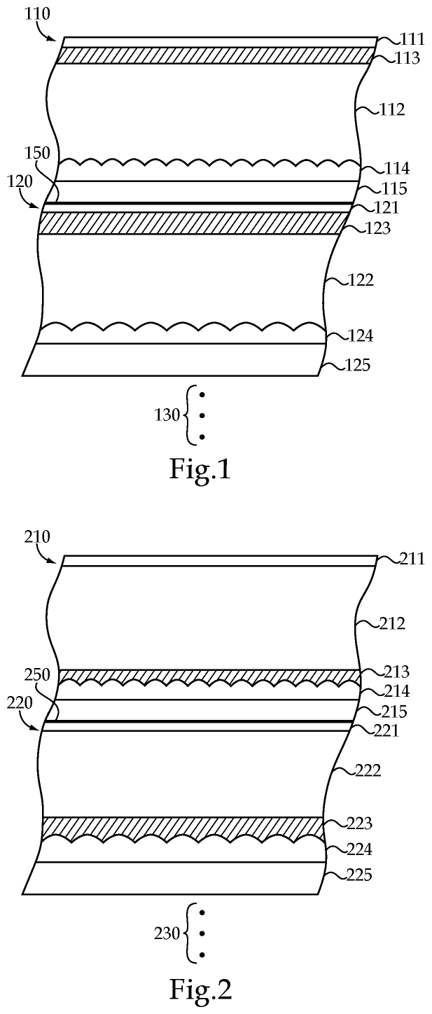

With reference to FIG. 1 there is illustrated a duct liner insulation article 110 including an insulation mat 112 comprising a uncured combination of a plurality of randomly oriented fibers and a binder. A number of types of uncured combinations may be utilized. The plurality of randomly oriented fibers may comprise mineral wool fibers such as fiberglass, rock wool or combinations thereof as well as other types of randomly oriented fibers. The binder may include one or more of a number of binder compounds including, for example, phenol formaldehyde (PF) binders, acrylic binders, polyester-type binders (e.g. those based on monomeric polycarboxylic acid and monomeric polyol, polymeric polycarboxylic acid and monomeric polyol, monomeric polycarboxylic acid and a polymeric polyol, or polymeric polycarboxylic acid and a polymeric polyol), Maillard chemistry based binders (e.g., glucose/ammonium citrate, glucose/ammonium sulfate, and glucose/ammonium phosphates including but not limited to glucose/monoammonium phosphate (MAP), glucose/diammonium phosphate (DAP) and glucose/triammonium phosphate (TAP)), as well as combinations of these and other binders.

In forming insulation mat 112 an uncured binder/fiber combination may be formed using a variety of techniques including, for example, using a spinner to form fibers from molten precursor material, admixing one or more binder compositions with the fibers, and collecting or aggregating the binder/fiber combination. Table 1 below lists a number of non-limiting examples of binder chemistries which may be utilized in forming insulation mat 112 and the pH of each binder in an uncured state (“pH of Uncured Binder”).

TABLE 1

| | | pH of Uncured |
|---|---|---|
| Ex. # | Binder Chemistry | Binder |
| 1 | Phenol-Formaldehyde | Alkaline |
| 2 | Acrylic | Acidic |
| 3 | Maillard Reaction | Alkaline |
| | (Ammonium Sulfate) | |
| 4 | Maillard Reaction | Alkaline |
| | (Diammonium Phosphate) | |
| 5 | Polyester based on | Acidic |
| | polycarboxylic acid and polyol | |

Table 2 below provides details as to binder formulations, designated A-H, that may be used in accordance with embodiments of the instant disclosure.

TABLE 2

| Binder | Constituents** | Solids | Ratio | Amount (g) |
|---|---|---|---|---|
| A | Water | | | 115.63 |
| | Dextrose | 90.9% | 80.34 | 82.44 |
| | AS | 40.0% | 16.82 | 39.22 |
| | NH3 | 19.0% | 2.52 | 12.37 |
| B | Water | | | 148.01 |
| | Dextrose | 90.9% | 76.4 | 95.3 |
| | DAP | 100.0% | 5.57 | 6.32 |
| C | Water | | | 46.07 |
| | PF-Urea | 47.1% | 100 | 186.09 |
| | AS | 40.0% | 4.5 | 9.86 |
| | NH₃ | 19.0% | 1.68 | 7.75 |
| D | Water | | | 79.1 |
| | SMA | 49.0% | 324.97 | 152.18 |
| | TEA | 100.0% | 81.57 | 18.72 |
| E | Water | | | 81.87 |
| | PAA | 48.0% | 100 | 143.94 |
| | Glycerol | 100.0% | 35 | 24.18 |
| F | Water | | | 81.87 |
| | PAA | 48.0% | 100 | 143.94 |
| | TEA | 100.0% | 35 | 24.18 |
| G | Water | | | 156.72 |
| | CA | 100.0% | 100 | 46.64 |
| | Glycerol | 100.0% | 100 | 46.64 |
| H | Water | | | 156.72 |
| | CA | 100.0% | 100 | 46.64 |
| | TEA | 100.0% | 100 | 46.64 |

**all binder formulations prepared as 37.31% binder solids
AS = ammonium sulfate
NH₃ = ammonia
DAP = diammonium phosphate
PF-Urea: GP ® 2894 resin pre-reacted with urea in a 70/30 (part/part) blend
SMA = Polyscope XIRAN ® 204 binder
TEA = triethanolamine
PAA = Rohm & Haas Acumer ™ 1000
CA = citric acid

The pH conditions for an uncured binder/fiber compositions for use in certain embodiments of the disclosure for various binders result in uncured binder/fiber compositions having particular characteristics that ultimately and beneficially enhance the commercial value and utility of the resulting, cured binder/fiber compositions. A number of uncured binder/fiber combinations have an acidic pH including, such as the examples listed in Tables 1 and 2 above.

In the embodiment illustrated in FIG. 1, a corrosion inhibitor 113 is deposited and on a first side of insulation mat 112 prior to curing the binder/fiber combination. Corrosion inhibitor 113 may be applied to the uncured binder/fiber combination using a number of techniques including, for example, as an aqueous spray, as a liquid, as a slurry, or as a powder. Those of skill in the art will appreciate that the application technique may be selected based upon considerations such as the solubility characteristics of a corrosion inhibitor and the application devices and equipment used in a given production process.

The chemical composition of corrosion inhibitor 113 may be selected to provide at least one of a pH neutralization effect relative to the characteristics of the uncured binder/fiber combination of insulation mat 112, a passivation effect relative to a metal surface which may come into contact or proximity with the duct liner insulation article 110, or a combination of both effects. Accordingly, corrosion inhibitor 113 may comprise a number of different chemical compositions depending on the characteristics of the uncured binder/fiber combination of insulation mat 112. For uncured binder/fiber combinations having an acidic pH, one or more chemical compound(s) characterized by an alkaline pH may be selected as the corrosion inhibitor 113. Table 3 below lists a number of non-limiting alkaline corrosion inhibitors, as well as their water solubility characteristics, for use in the present technology.

TABLE 3

| Ex. | | |
|---|---|---|
| # | Alkaline Corrosion Inhibitor | Solubility Characteristic |
| 1. | sodium hydroxide | water soluble |
| 2. | sodium carbonate | water soluble |
| 3. | sodium bicarbonate | water soluble |
| 4. | potassium hydroxide | water soluble |
| 5. | potassium carbonate | water soluble |
| 6. | potassium bicarbonate | water soluble |
| 7. | ammonium carbonate | water soluble |
| 8. | ammonium bicarbonate | water soluble |
| 9. | monoethanolamine | water soluble |
| 10. | diethanolamine | water soluble |
| 11. | triethanolamine | water soluble |
| 12. | zinc phosphate | essentially water insoluble |
| 13. | calcium phosphate | essentially water insoluble |
| 14. | long chain alkyl imidazoline (e.g. those | essentially water insoluble |
| | offered commercially by Lonza under | |
| | the registered trademarks | |
| | UNAMINE ® O and | |
| | UNAMINE ® C) | |

In forms where a corrosion inhibitor with an alkaline pH is selected, the corrosion inhibitor 113 may comprise one or more of the alkaline corrosion inhibitors listed in Table 3 above as well as combinations thereof. In further forms where a corrosion inhibitor with an alkaline pH is selected, the corrosion inhibitor 113 may consist essentially of any of the alkaline corrosion inhibitors listed in Table 3 above or may consist essentially of a combination of two or more of the alkaline corrosion inhibitors listed in Table 3 above. It shall be further appreciated that other alkaline corrosion inhibitors may also be utilized in addition to or instead of the non-limiting examples disclosed herein.

For uncured binder/fiber combinations having an alkaline pH, one or more chemical compound providing an acidic pH may be selected as the corrosion inhibitor 113. Table 4 below lists a number of acidic corrosion inhibitors that may be utilized in the disclosed technology.

TABLE 4

| Ex. # | Acidic Corrosion Inhibitor |
|---|---|
| 1. | Tetraaquahydrogen |
| 2. | Sodium bicarbonate |
| 3. | Potassium bicarbonate |
| 4. | Magnesium bicarbonate |
| 5. | Calcium bicarbonate |
| 6. | Ammonium bicarbonate |

In embodiments where a corrosion inhibitor with an acidic pH is utilized, the corrosion inhibitor 113 may comprise one or more of the acidic corrosion inhibitors listed in Table 4 above, including combinations thereof. In further embodiments where a corrosion inhibitor with an acidic pH is selected, the corrosion inhibitor 113 may consist essentially of any of the acidic corrosion inhibitors listed in Table 4, including combinations of two or more of the acidic corrosion inhibitors listed in Table 4. In still further embodiments, additional acidic corrosion inhibitors may also be utilized in addition to or instead of the non-limiting examples disclosed herein.

The physical location and extent of the corrosion inhibitor 113 is shown generally in FIG. 1 for purposes of illustration, and the skilled artisan will appreciate that a number of locations and extents may be utilized. In certain embodiments, the corrosion inhibitor 113 may be deposited and positioned substantially or entirely on the surface of the first side of the insulation mat 112. In further embodiments, the corrosion inhibitor 113 may be deposited on the surface of the first side of the insulation mat 112 and may also extend into the insulation mat 112. The degree to which the corrosion inhibitor 113 extends into the insulation mat 112 may vary depending upon the form in which the corrosion inhibitor is applied (e.g., powder form, liquid, aqueous solution, slurry), the amount and/or concentration of corrosion inhibitor applied, and the application technique utilized to apply the corrosion inhibitor. For certain “spray-on” applications, inhibitors may be applied in some embodiments at the 0.1-2 g/ft² range with regards to the active ingredient. Examples of corrosion inhibitors which are effective in this range include sodium carbonate (NaCO₃), sodium bicarbonate (NaHCO₃), potassium hydroxide (KOH), triethanolamine (TEA), 2-nitrophenol, sodium molybdate (Na₂MoO₄) and cerium chloride (CeCl₃).

As further illustrated in FIG. 1, a veil 111 is affixed to the first side of the insulation mat 112. The veil 111 may be structured in certain embodiments to inhibit physical movement of the uncured binder/fiber combination past the veil 111 while allowing the passage of vapor or liquid, although the veil 111 may not entirely prevent physical movement of the uncured binder/fiber composition and may permit the passage of some amount of the uncured binder/fiber composition comprising applied corrosion inhibitor(s) (e.g., a small amount of loose fiber) through veil 111. In certain embodiments, the veil 111 may comprise a fiberglass veil, or blends of glass and thermoplastic elastomeric (TPE) fibers such as veils comprising combinations or blends of fiberglass and polyester(s). The veil 111 may be affixed to the first side of insulation mat using an adhesive, wherein a water based adhesive, a hot melt adhesive or a non-water based adhesive may be utilized. In certain embodiments, a variety of water based adhesives may be utilized, which in certain embodiments may have a pH which is either neutral or which corresponds to the pH of the selected corrosion inhibitor. In non-limiting examples, acidic to neutral pH adhesives may be used in combination with acidic corrosion inhibitors, and alkaline to neutral pH adhesives may be used in combination with alkaline corrosion inhibitors.

The second side of insulation mat 112 is affixed to metal sheet 115 by adhesive 114, which may be a water containing adhesive such as the VAE laminating adhesive 82000 adhesive offered commercially by EFI Polymers. Other suitable adhesives types include, for example, water-born adhesives, latex emulsions, e.g. polyvinyl acetate (PVA) emulsions, polyacrylate emulsions, ethylene vinyl acetate (EVA) emulsion, and styrene-butadiene emulsions. Metal sheet 115 may be a steel sheet, a stainless steel sheet, or a galvanized steel sheet, wherein the physical location and extent of the adhesive is shown for general reference in FIG. 1, as a number of locations and extents for adhesive application may be utilized in accordance with the present disclosure. In one non-limiting example, 82000 adhesive may be applied at a rate of 60 g/ft2 to a galvanized steel sheet to affix a one-inch thick insulation mat comprising a uncured combination of fiberglass and a Maillard chemistry based binder such as a dextrose diammonium phosphate (DAP) binder comprising an all-glass veil affixed to the insulation mat.

FIG. 1 further illustrates duct liner insulation article 120 which comprises insulation mat 122, corrosion inhibitor 123, veil 121, adhesive 124 and metal sheet 125. The characteristics and properties of these components of duct liner insulation article 120 may be substantially the same as insulation mat 112, corrosion inhibitor 113, veil 111, adhesive 114 and metal sheet 115 of duct liner insulation article 110 as described above.

Duct liner insulation articles 110 and 120 of the various compositions and combinations described herein above may be produced according to a process including one or more of the following operations: (a) forming an insulation mat comprising an uncured binder/fiber combination; (b) applying a corrosion inhibitor composition to a first side of the uncured insulation mat; (c) optionally applying a corrosion inhibitor composition to a second side of the uncured insulation mat; (d) affixing a veil to the first side of the insulation mat with a first adhesive; (e) curing the insulation mat to provide an uncured binder/fiber combination; (f) affixing the second side of the insulation mat to a metal sheet with a second adhesive; (f) repeating process operations (a) through (f) to provide a plurality of articles; (g) positioning the resulting articles in contact or proximity with one another; (h) allowing the second adhesive to cure or set for a predetermined period of time; and (i) further forming duct structures using one or more articles as described above.

The configuration illustrated in FIG. 1 depicts portions of a plurality of duct liner insulation articles including article 110 and article 120 which are positioned in a stack with veil 121 contacting a show side of metal sheet 115 at interface 150. As indicated by ellipsis 130 additional duct liner insulation articles may also be provided in the stack. It shall be further appreciated that the stacked position of article 110 and article 120 encompass non-limiting embodiments of a configuration in which a portion of one duct liner insulation article may be in contact with or proximity with a portion of another duct liner insulation article. In alternative configurations, adjacent articles may be spaced apart or may be in contact with one another over certain regions and spaced apart in other regions. The illustrated configuration is but one example of a configuration presenting potential for undesired consequences such as hazing, corrosion, or other chemical reactions affecting the “show side” of a duct liner insulation article.

Without wishing to be limited to any particular mechanisms or theories, the structure and composition of articles 110 and 120 are believed to mitigate the potential for undesired consequences such as hazing, corrosion, or other chemical reactions affecting the “show side” of a duct liner insulation article by a pH neutralization effect relative to the characteristics of an uncured binder/fiber combination of insulation mat 112 lacking the corrosion inhibitor application described herein, a passivation effect relative to the show side of metal sheet 115, or a combination of both effects. After articles 110 and 120 are initially assembled, adhesives 113 and 123 transition from a wet or unfixed state to a dried or fixed state over a period of time. Moisture from adhesive 113 and 123 may travel through insulation mats 112 and 122, respectively. As this moisture interacts with the uncured binder/fiber combination an acidic or alkaline pH may be imparted to the moisture. Accordingly, the pH neutralization effect of corrosion inhibitors 113 and 123 is believed to modify the pH of the moisture in contact with the uncured binder/fiber combination toward neutral by providing an opposing pH, resulting in a “neutralizing” reaction with respect to pH. The passivation effect of corrosion inhibitors 113 and 123 is believed to involve movement of the corrosion inhibitor through the insulation mats 112 and 122 and veils 111 and 121 to contact an adjacent metal surface where the corrosion inhibitor passivates the metal surface by chemically interacting with binding sites that might otherwise be reactive to the pH of the uncured binder/fiber composition.

In compositions and processes that include the use of galvanized metal sheets a particular mechanism of action may occur wherein an initially shiny metal surface of the zinc metal reacts with the moisture to form hydrated zinc oxides. The surface areas in contact with moisture can become dulled and also exhibit a white haze. The appearance of the surface is non-uniform and is objectionable for aesthetic and/or commercial applications, especially in those cases where the affected surface is an exposed surface or “show side” in construction applications. Mitigating these issues is not simple or straightforward and represents a well-established problem in the insulation and building industries. One complication is that the presence of acidic or alkaline compounds, such as the disclosed corrosion inhibitors, may themselves provide undesired corrosion or reactions producing similar results. Another complication is that the corrosion inhibitors themselves may produce objectionable results, for example, providing a non-uniform or blemished surface when applied directly to a metal surface or directly onto the surface of an adjacent article that comes in contact of the galvanized steel. Additionally, the identification of concentrations and/or application densities for the corrosion inhibitor system is not straightforward and can significantly vary between application processes and corrosion inhibitor systems. In many instances the applied corrosion inhibitors form an undesirable film or crust on the galvanized steel surface. In these embodiments a surprising result occurred by application of the corrosion inhibitor to the uncured composition as illustrated in FIG. 1. While the corrosion inhibitor was free to pass through the veil and induce the pH neutralization and/or passivation effect as well as the undesired results noted above, it was observed in practice that the beneficial effects outlined above were present, in lieu of the aforementioned, undesired effects and complications.

With reference to FIG. 2, additional embodiments comprising a plurality of duct liner insulation articles including duct liner insulation articles 210 and 220 are illustrated. In some embodiments, additional duct liner insulation articles may be included as indicated by ellipsis 230. Articles 210 and 220 include a number components which may have the same or similar characteristics and properties as corresponding components illustrated and described above in connection with FIG. 1. FIG. 2 illustrates corresponding components labeled with numerals incremented by 100 relative to those of FIG. 1, e.g., insulation mat 212, corrosion inhibitor 213, veil 211, adhesive 214 and metal sheet 215 of article 210 correspond to insulation mat 112, corrosion inhibitor 113, veil 111, adhesive 114 and metal sheet 115 of article 110, respectively. Similarly, insulation mat 222, corrosion inhibitor 223, veil 221, adhesive 224 and metal sheet 225 of article 220 correspond to insulation mat 122, corrosion inhibitor 123, veil 121, adhesive 124 and metal sheet 125 of article 120, respectively. Likewise, ellipsis 230 corresponds to ellipsis 130, and interface 250 corresponds to interface 150. The different forms, compositions, variations and alternative embodiments described in connection with the embodiment of FIG. 1 apply to the embodiments of FIG. 2.

It shall be appreciated that the embodiment of FIG. 2 differs from the embodiments of FIG. 1 in certain respects which shall now be described. In the embodiment illustrated in FIG. 2, corrosion inhibitor 213 is deposited on the bottom side of insulation mat 212 which faces adhesive 214 and metal sheet 215. This configuration permits veil 211 to be affixed to the top side of insulation mat 212 using additional techniques. In one non-limiting example, insulation mat 212 may initially comprise an uncured binder/fiber combination, veil 211 may be placed on the upper side of insulation mat 212 in the uncured state, and the insulation mat 212 and veil 211 may be uncured in this configuration effective to affix veil 211 to insulation mat 212, with eventual curing and application to the bottom side of the insulation mat 212 and subsequent completion of the commercial product(s). The bottom side of insulation mat 212 may then be affixed to metal sheet 215 with adhesive 214. In certain embodiments the amount of corrosion inhibitor applied to the bottom side of insulation mat 212 and/or the degree of penetration into insulation mat 212 may be the same as or may be increased relative to the embodiment illustrated in FIG. 1.

Although the present disclosure is primarily directed to uncured compositions comprising the uncured binder/fiber combinations contemplated herein, duct liner insulation articles that are well known to those of skill in the relevant arts may be produced by processing the uncured binder/fiber combinations comprising one or more corrosion inhibitors according to previously reported techniques and processes, which may comprise one of more of the steps pf (a) applying a veil to the first side of an insulation mat; (b) curing the insulation mat in contact with the veil to provide a cured binder/fiber combination affixed to the veil; (c) affixing the second side of the insulation mat to a metal sheet with an adhesive; (d) repeating process operations (a) through (c) to provide a plurality of articles; (e) positioning the resulting articles in contact with or proximal to one another; (f) allowing the adhesive to set for a predetermined period of time; and (g) further forming duct structures using one or more articles.

Alternate techniques and orders of operations for applying the veil may be utilized including, for example, those described above in connection with FIG. 1. Moreover, the structure and composition of articles 210 and 220 are believed to mitigate the potential for the aforementioned, disadvantageous and undesired consequences such as hazing, corrosion, or other chemical reactions affecting the “show side” of a duct liner insulation article by a pH neutralization effect relative to the characteristics of the uncured binder/fiber combination of the insulation mats, and a passivation effect relative to the “show side” of an adjacent or proximal metal sheet, or a combination of these effects. These effects may exhibit the characteristics described above in connection with FIG. 1.

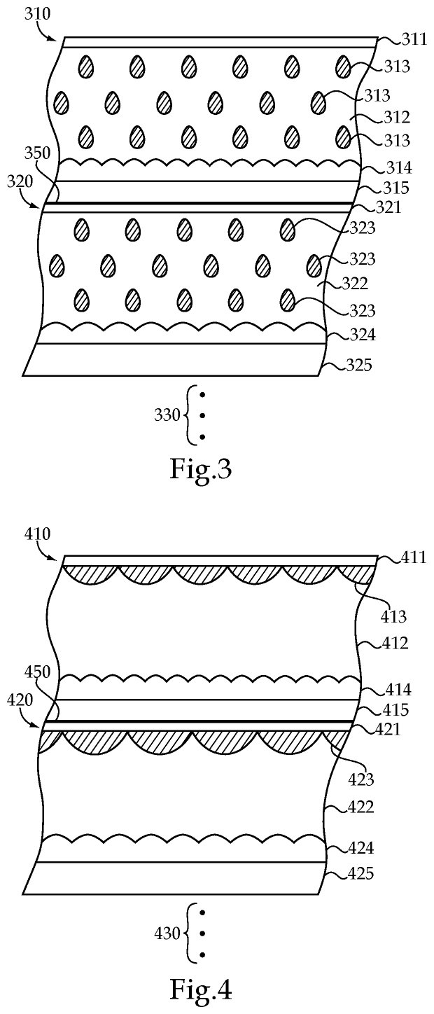

Referring now to FIG. 3, additional embodiments related to a plurality of duct liner insulation articles including duct liner insulation articles 310 and 320 are illustrated. It is contemplated that additional duct liner insulation articles may also be included as indicated by ellipsis 330. Articles 310 and 320 include a number components which may have the same or similar characteristics and properties as corresponding components illustrated and described above in connection with FIG. 1. In FIG. 3 corresponding components are labeled with references numerals incremented by 200 relative to those of FIG. 1, and accordingly incremented by 100 relative to those in FIG. 2. Thus, insulation mat 312, corrosion inhibitor 313, veil 311, adhesive 314 and metal sheet 315 of article 310 correspond to insulation mat 112, corrosion inhibitor 113, veil 111, adhesive 114 and metal sheet 115 of article 110, respectively. Similarly, insulation mat 322, corrosion inhibitor 323, veil 321, adhesive 324 and metal sheet 325 of article 320 correspond to insulation mat 122, corrosion inhibitor 123, veil 121, adhesive 124 and metal sheet 125 of article 120, respectively. Likewise, ellipsis 330 corresponds to ellipsis 130, and interface 350 corresponds to interface 150. The different forms, compositions, variations and alternatives described in connection with some of the embodiments exemplified FIG. 1 also apply to the corresponding embodiments of FIG. 3.

As will be appreciated by the skilled artisan, embodiments of FIG. 3 may differ from certain and corresponding embodiments in FIG. 1. For instance, as shown in FIG. 3 corrosion inhibitor 313 may be deposited at a plurality of locations within the thickness of uncured insulation mat 312. In certain embodiments this configuration permits veil 311 to be affixed to the top side of insulation mat 312 using any of the techniques described above in connection with FIGS. 1 and 2. Corrosion inhibitor 313 may be applied to the plurality of locations within insulation mat 312 using a number of techniques known in the relevant art, which include techniques that utilize apparatuses comprising injection or application needles or nozzles which penetrate into the thickness of insulation mat 312 to various predetermined depths, including jet spray injectors which direct a stream of corrosion inhibitor that penetrates into the thickness of the insulation mat. These application techniques may penetrate into either side of insulation mat 312. The corrosion inhibitor 313 may be applied prior to or after veil 311 is affixed to the insulation mat 312. Likewise, the corrosion inhibitor 313 may be applied prior to or after the insulation mat 312 is affixed to metal sheet 315. The bottom side of insulation mat 312 may be affixed to metal sheet 315 with adhesive 314.

Duct liner insulation articles 310 and 320 of the various compositions and combinations described herein above may be produced according to a process including the following operations: (a) forming an insulation mat comprising an uncured binder/fiber combination, (b) applying a veil to the first side of the insulation mat, (b) applying a corrosion inhibitor composition at interior locations in the insulation mat using techniques such as penetrating injection needles, penetrating injection nozzles, or penetrating sprays, (c) curing the insulation mat in contact with the veil to provide a cured binder/fiber combination affixed to the veil, (e) affixing the second side of the insulation mat to a metal sheet with an adhesive, (f) repeating process operations (a) through (e) to provide a plurality of articles, (g) positioning the resulting articles in contact with or proximity with one another, (h) allowing the adhesive to set for a predetermined period of time, and (i) further forming duct structures using one or more articles.

Alternate techniques and orders of operation for applying the veil may be utilized including, for example, those described above in connection with FIG. 1. As would be appreciated by those of skill in the relevant arts, the structure and composition of articles 310 and 320 are believed to mitigate the potential for deleterious effects on the articles and/or components of the articles such as hazing, corrosion, and/or other chemical reactions affecting the “show side” of a duct liner insulation article by a pH neutralization treatment relative to the characteristics of the uncured binder/fiber combination of the insulation mats, and a passivation effect relative to the “show side” of an adjacent metal sheet or sheets, or a combination of these effects. These effects may have the characteristics described above in connection with FIG. 1.

With reference to FIG. 4, additional embodiments comprising a plurality of duct liner insulation articles including duct liner insulation articles 410 and 420 are illustrated. Additional duct liner insulation articles may also be included in the context of the present disclosure as indicated by ellipsis 430. Articles 410 and 420 may comprise a number components which may have the same or similar characteristics and properties as corresponding components illustrated and described above in connection with FIG. 1. In FIG. 4, corresponding components are labeled with reference numerals incremented by 300 relative to those of FIG. 1. Thus, insulation mat 412, corrosion inhibitor 413, veil 411, adhesive 414 and metal sheet 415 of article 410 correspond to insulation mat 112, corrosion inhibitor 113, veil 111, adhesive 114 and metal sheet 115 of article 110, respectively. Similarly, insulation mat 422, corrosion inhibitor 423, veil 421, adhesive 424 and metal sheet 425 of article 420 correspond to insulation mat 122, corrosion inhibitor 123, veil 121, adhesive 124 and metal sheet 125 of article 120, respectively. Likewise, ellipsis 430 corresponds to ellipsis 130, and interface 450 corresponds to interface 150. The different forms, compositions, variations and alternative components and embodiments described in connection with the embodiment of FIG. 1 also apply to the forms, compositions, variations and alternative components and embodiments of FIG. 4.

It shall be appreciated that certain embodiments of FIG. 4 differ from the embodiment of FIG. 1 in certain respects which are similar to the differences described above in connection with FIG. 3. In embodiments depicted in FIG. 4 the corrosion inhibitor 413 may be deposited using techniques similar to those described above in connection with FIG. 3. The position of corrosion inhibitor 413 differs in that it is controlled to be at locations within insulation mat 412 that are proximal to veil 411. This manipulation may be accomplished by varying the depth or penetration of the application needle or nozzle or the intensity of the penetrating jet spray. The production processes described above in connection with FIG. 3 may also be utilized for production of the articles illustrated in the embodiment of FIG. 4.

While the technology has been illustrated and described in detail in the drawings and foregoing description, the same is to be considered as illustrative and not restrictive in character, it being understood that only certain exemplary embodiments have been shown and described and that all changes and modifications that come within the spirit of the disclosure are desired to be protected. Accordingly, no limitation of the scope of the disclosure is thereby created, and that the technology includes and protects such alterations, modifications, and further applications of the exemplary embodiments as would occur to one skilled in the art. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An article of manufacture comprising:
an insulation mat comprising an uncured combination of a plurality of randomly oriented fibers comprising fiberglass fibers or rock wool fibers and a non-phenol formaldehyde (non-PF) composition binder, wherein the insulation mat extends between a first surface and a second surface;
a veil attached to the first surface, wherein the veil is structured to inhibit physical movement of the cured combination through the veil;
a metal sheet attached to the second surface by a water-containing adhesive contacting the metal sheet and the second surface; and
a corrosion inhibitor composition deposited on the uncured combination of the insulation mat, wherein the corrosion inhibitor composition modifies toward neutral a pH of the uncured combination in contact with water from the water-containing adhesive.

2. The article of manufacture of claim 1, wherein the uncured combination has an acidic pH and the corrosion inhibitor composition has an alkaline pH.

3. The article of manufacture of claim 2, wherein the corrosion inhibitor composition comprises a water soluble compound selected from the group consisting of sodium hydroxide, sodium carbonate, sodium bicarbonate, potassium hydroxide, potassium carbonate, potassium bicarbonate, ammonium carbonate, ammonium bicarbonate, monoethanolamine, diethanolamine, triethanolamine and combinations thereof.

4. The article of manufacture of claim 2, wherein the corrosion inhibitor composition comprises a water insoluble compound selected from the group consisting of zinc phosphate, calcium phosphate, a long chain alkyl imidazoline and combinations thereof.

5. The article of manufacture of claim 1, wherein the corrosion inhibitor composition is deposited on the first surface of the insulation mat.

6. The article of manufacture of claim 1, wherein the binder is selected from an acrylic binder, a polyester-type binder, a binder comprising at least one reaction product from a Maillard reaction, and combinations thereof.

7. The article of manufacture of claim 1, wherein the binder comprises a polyester-type binder selected from the group consisting of:
a monomeric polycarboxylic acid and a monomeric polyol,
a polymeric polycarboxylic acid and a monomeric polyol,
a monomeric polycarboxylic acid and a polymeric polyol, and
a polymeric polycarboxylic acid and a polymeric polyol.

8. The article of manufacture of claim 1, wherein the binder comprises at least one or more of a) at least one reaction product from a Maillard reaction; b) at least one product of a carbohydrate and an amine reactant; and c) at least one product of a reducing sugar reactant and a polycarboxylic acid ammonium salt reactant.

9. The article of manufacture of claim 1, wherein the metal sheet is galvanized.

10. An article of manufacture comprising:
an insulation mat comprising an uncured combination of a plurality of randomly oriented fibers and a binder, the insulation mat comprising a corrosion inhibitor composition and extending between a first surface and a second surface, wherein the corrosion inhibitor comprises the opposite of one of the acidic pH and the alkaline pH of the uncured composition when immersed in deionized water; and
a veil attached to the first surface, the veil structured to inhibit physical movement of the cured combination through the veil;
wherein the article of manufacture is capable of being cured.

11. The article of manufacture of claim 10, further comprising a metal sheet attached to the second surface by a water-comprising adhesive contacting the metal sheet and the second surface.

12. The article of manufacture of claim 10, wherein the corrosion inhibitor composition is effective to modify toward neutral a pH of the uncured combination in contact with water from the water-containing adhesive.

13. The article of manufacture of claim 10, wherein the veil is positioned in contact with a surface of a second, galvanized metal sheet.

14. The article of manufacture of claim 10, wherein the corrosion inhibitor composition provides passivation of the surface of the second metal sheet.

15. The article of manufacture of claim 10, wherein the binder comprises at least one reaction product from a Maillard reaction, the uncured composition has an acidic pH, and the corrosion inhibitor composition has an alkaline pH.

16. A method comprising:
providing an insulation mat comprising an uncured combination of a plurality of randomly oriented fibers and a binder and a veil attached to a first surface of the cured combination and effective to inhibit physical movement of the cured combination through the veil;
applying a corrosion inhibitor composition to the uncured combination of the insulation mat;
curing the uncured combination of a plurality of randomly oriented fibers, a binder, a veil and a corrosion inhibitor;
attaching a metal sheet to a second surface of the cured combination with a water-containing adhesive contacting the metal sheet and the second surface; and
contacting the veil with a second metal sheet;
wherein the corrosion inhibitor composition is effective to inhibit a reaction of water from the water-containing adhesive, the uncured combination and the second metal sheet.

17. The method of claim 16, wherein the corrosion inhibitor composition is effective to modify toward neutral a pH of the uncured combination in contact with water from the water-containing adhesive.

18. The method of claim 16, wherein the corrosion inhibitor composition is effective to passivate a surface of the second metal sheet.

19. The method of claim 16, wherein the act of applying comprises applying the corrosion inhibitor composition to a second surface of the uncured combination of the insulation mat, the second surface being opposite from the first surface.

20. The method of claim 19, wherein the corrosion inhibitor composition is applied to the second surface by spraying an aqueous solution comprising the corrosion inhibitor composition and an aqueous slurry including the corrosion inhibitor composition.
